(19) United States
(12) Patent Application Publication
(10) Pub. No.: US 2026/0035608 A1
(43) Pub. Date: Feb. 5, 2026

(54) SCALE INHIBITION IN A WELLBORE

(71) Applicant: KING FAHD UNIVERSITY OF PETROLEUM AND MINERALS, Dhahran (SA)

(72) Inventors: Syed Muhammad Shakil HUSSAIN, Dhahran (SA); Mobeen MURTAZA, Dhahran (SA); Muhammad Shahzad KAMAL, Dhahran (SA); Murtada AL-JAWAD, Dhahran (SA); Mohamed MAHMOUD, Dhahran (SA)

(73) Assignee: KING FAHD UNIVERSITY OF PETROLEUM AND MINERALS, Dhahran (SA)

(21) Appl. No.: 19/047,187

(22) Filed: Feb. 6, 2025

Related U.S. Application Data
(60) Provisional application No. 63/679,019, filed on Aug. 2, 2024.

(51) Int. Cl. C09K 8/532

(52) U.S. Cl. CPC C09K 8/532

(57) ABSTRACT

A method of inhibiting sulfate-including scale formation in a high-pressure high-temperature (HPHT) wellbore includes injecting a chemical scale inhibitor into a wellbore disposed in a subterranean geological formation to form a chemical scale inhibitor composition in the wellbore. The method further includes contacting a wall of the wellbore with the chemical scale inhibitor composition to delay an onset of sulfate-including scale formation on the wall of the wellbore. The chemical scale inhibitor is a sulfobetaine zwitterionic surfactant.

### CROSS REFERENCE TO RELATED APPLICATIONS

This application claims the benefit of priority of U.S. Provisional Application No. 63/679,019 filed Aug. 2, 2024, the entire contents of which are herein incorporated by reference.

### BACKGROUND

### Technical Field

The present disclosure is directed towards scale inhibition techniques, and more particularly, towards a method of inhibiting scale formation in a high-pressure high-temperature (HPHT) wellbore.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

In the oil and gas industry, scale refers to the undesirable precipitation and accumulation of solids inside wellbores, pipelines, and production equipment. Scale formation is a major problem in the oil and gas industry because it may cause lower efficiency, increase maintenance costs, and increase the prevalence equipment malfunction due to the decreased flow capability of the wellbore. Scale formations may include mineral deposits such as calcium carbonate, calcium sulfate, and barium sulfate that form within pipes, valves, and processing equipment. Scaling can may in various locations, including inside the reservoir, near the wellbore area, within production tubulars, in topside facilities, and in wells used for re-injecting produced water.

Removing scale formation is challenging due to its acid resistance. Conventionally, scale formation may be removed by use of chemical solutions, such as calcium hydroxide. Conventional chemical solutions for scale removal, however, may lead to sludge accumulation, necessitating an acid wash after use, which may lead to equipment damage and exposure to toxic chemicals for drill workers. Temperature and pressure may also significantly affect the effectiveness of chemical scale inhibitors, with higher temperatures often leading to decreased inhibitor performance and high pressure sometimes impacting stability, meaning the inhibitor may degrade or become less effective under extreme conditions. Thus, there is a need for an effective chemical scale inhibitor that does not need a subsequent acid wash to remove remaining scale formations, and which is able to perform well in high pressure and high temperature drilling environments.

Accordingly, one object of the present disclosure is to provide a chemical scale inhibitor for scale inhibition in a high-pressure high-temperature (HPHT) wellbore.

### SUMMARY

In an exemplary embodiment, a method of inhibiting sulfate-comprising scale formation in a high-pressure high-temperature (HPHT) wellbore is described. The method comprises injecting a chemical scale inhibitor into a wellbore disposed in a subterranean geological formation to form a chemical scale inhibitor composition in the wellbore. The method further comprises contacting a wall of the wellbore with a chemical scale inhibitor composition to delay an onset of sulfate-comprising scale formation on the wall of the wellbore. The chemical scale inhibitor is a sulfobetaine zwitterionic surfactant of Formula I

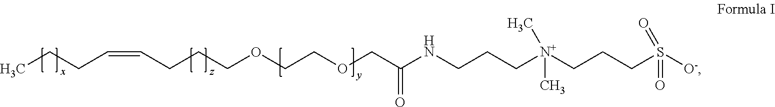

where x, y, and z are individually an integer from 1 to 20, the chemical scale inhibitor composition comprises at least 50 ppm of the sulfobetaine zwitterionic surfactant, and the onset of sulfate-comprising scale formation is delayed by at least 24 h. The wall of the wellbore contacted with the chemical scale inhibitor is at a temperature of at least 100° F.

In some embodiments, the sulfate-comprising scale comprises at least one selected from the group consisting of barium sulfate, calcium sulfate, and strontium sulfate.

In some embodiments, no sulfate-comprising scale precipitate is formed in an aqueous composition, which comprises 0.1 to 0.5 grams per liter (g/L) NaHCO₃, 0.5 to 7 g/L Na₂SO₄, 40 to 155 g/L NaCl, 2 to 70 g/L CaCl₂·2H₂O, 17 to 22 g/L MgCl₂·6H₂O, and 100 to 500 ppm of the sulfobetaine zwitterionic surfactant at a temperature of 100° F. to 160° F.

In some embodiments, the contacting is performed for at least 1 hour.

In some embodiments, the sulfate-comprising scale comprises barium sulfate.

In some embodiments, no sulfate-comprising scale precipitate is formed in an aqueous composition comprising 0.15 to 0.5 g/L NaHCO₃, 0.5 to 6.5 g/L Na₂SO₄, 41 to 151 g/L NaCl, 2.3 to 70 g/L CaCl₂·2H₂O, 17.5 to 21 g/L MgCl₂·6H₂O, and 100 to 500 ppm of the sulfobetaine zwitterionic surfactant at a temperature of 100° F. to 160° F.

In some embodiments, the chemical scale inhibitor composition further comprises at least one additive selected from the group consisting of an ammonium salt, a cross-linking agent, a proppant, an oxygen scavenger, a corrosion inhibitor, a fluid-loss additive, a friction reducer, a chelating agent, a dispersant, a wetting agent, a scale disperser, a pH stabilizer, a de-emulsifier, a hydrate inhibitor, a clay stabilizer, an anti-foaming agent, a viscosifier, a fluid stabilizer, a thermal stabilizer, a flow enhancer, a scale dissolver, a fouling inhibitor, a defoamer, a crystallization inhibitor, and a scale modifier.

In some embodiments, the wall of the wellbore contacted with the chemical scale inhibitor composition is at a temperature of 100° F. to 160° F.

In some embodiments, the sulfate-comprising scale comprises calcium sulfate.

In some embodiments, the chemical scale inhibitor composition comprises at least 100 ppm of the sulfobetaine zwitterionic surfactant.

In some embodiments, ‘x’ is 1 and ‘y’ is an integer from 1 to 10.

In some embodiments, the wall of the wellbore contacted with the chemical scale inhibitor composition is at a temperature of 150° F.

In some embodiments, the contacting is performed for at least 24 hours.

In some embodiments, the chemical scale inhibitor composition further comprises a synthetic seawater comprising 0.1 to 0.2 g/L NaHCO₃, 5.5 to 6.5 g/L Na₂SO₄, 41 to 42 g/L NaCl, 2 to 3 g/L CaCl₂·2H₂O, and 17 to 18 g/L MgCl₂·6H₂O, and/or a formation water comprising 0.4 to 0.5 g/L NaHCO₃, 0.5 to 0.6 g/L Na₂SO₄, 150 to 151 g/L NaCl, 69 to 70 g/L CaCl₂·2H₂O, and 20 to 21 g/L MgCl₂·6H₂O.

In some embodiments, the chemical scale inhibitor composition further comprises a brine comprising a synthetic seawater and a formation water, and the brine has a weight ratio of the synthetic seawater to the formation water of 1:3 to 3:1.

In some embodiments, the chemical scale inhibitor composition comprises at least 500 ppm of the sulfobetaine zwitterionic surfactant.

In some embodiments, the chemical scale inhibitor composition has a viscosity of 1 centipoise (cP) to 100 cP.

In some embodiments, the chemical scale inhibitor composition has a density of 1.15 g/cm³ to 1.30 g/cm³.

In some embodiments, the chemical scale inhibitor composition has a pH of 3 to 7.

In some embodiments, the chemical scale inhibitor composition has a density of 1.23 g/cm³ to 1.25 g/cm³.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of inhibiting sulfate-comprising scale formation in an HPHT wellbore, according to certain embodiments.

FIG. 2A is an optical image of a plurality of test tubes comprising a base sample, a sample with 100 ppm chemical scale inhibitor, and a sample with 500 ppm chemical scale inhibitor, at the commencement of evaluations, according to certain embodiments.

FIG. 2B is an optical image of the plurality of test tubes comprising the base sample, the sample with 100 ppm chemical scale inhibitor, and the sample with 500 ppm chemical scale inhibitor, at 24 hours of evaluations, according to certain embodiments.

FIG. 2C is an optical image of the plurality of test tubes comprising the base sample, the sample with 100 ppm chemical scale inhibitor, and the sample with 500 ppm chemical scale inhibitor, at 7 days of evaluations, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “wellbore” refers to the hole or shaft drilled into the earth's surface to access underground formations, such as oil, gas, or water reservoirs. It is typically created through drilling operations and can vary in depth and diameter depending on the target formation and the specific requirements of the drilling process. The wellbore serves as the conduit for the extraction of fluids or gases, and can also be used for injecting fluids, including chemicals like scale inhibitors, for reservoir management or enhanced recovery processes.

As used herein, the term “chemical scale inhibitor” refers to a substance or formulation that is used to prevent or reduce the formation and deposition of scale, such as mineral salts, in oil and gas wells, pipelines, and production equipment. These inhibitors interfere with the crystal growth of scale-forming minerals, preventing them from adhering to surfaces and causing blockages or damage. Chemical scale inhibitors may be in the form of organic or inorganic compounds, such as surfactants, chelating agents, or polymers.

As used herein, the term “subterranean geological formation” refers to a naturally occurring layer or stratum of rock, sediment, or soil located beneath the earth's surface. These formations often contain valuable resources such as oil, gas, minerals, or groundwater. Subterranean geological formations are typically accessed through wellbores drilled into the earth for exploration or extraction purposes.

As used herein, the term “sulfate-comprising scale formation” refers to the accumulation and deposition of scale primarily composed of sulfate minerals, such as barium sulfate (BaSO₄), calcium sulfate (CaSO₄), or strontium sulfate (SrSO₄), in oil and gas production systems. These scales typically form when incompatible fluids, rich in sulfate ions, mix with fluids comprising calcium, barium, or strontium ions, leading to the precipitation of these sulfate compounds. Sulfate-comprising scale formation can obstruct pipelines, production equipment, and wellbores, reducing operational efficiency and increasing maintenance costs.

Aspects of this disclosure are directed to a method of inhibiting sulfate-comprising scale formation in an HPHT wellbore. Inhibiting sulfate-comprising scale formation in HPHT wellbores is important for maintaining optimal fluid flow, preventing equipment damage, and reducing downtime and maintenance.

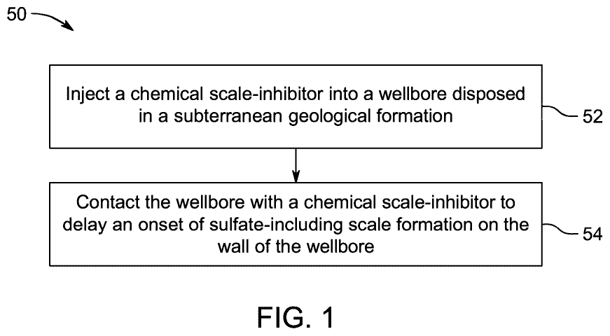

A method of inhibiting sulfate-comprising scale formation in an HPHT wellbore is described. FIG. 1 illustrates a schematic flow chart of a method 50 of inhibiting sulfate-comprising scale formation in an HPHT wellbore. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 comprises injecting a chemical scale inhibitor into a wellbore disposed in a subterranean geological formation to form a chemical scale inhibitor composition in the wellbore. In an embodiment, the chemical scale inhibitor is a sulfobetaine zwitterionic surfactant of Formula I

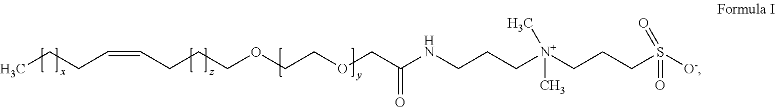

where x, y, and z are individually an integer from 1 to 20. In some embodiments, x, y and/or z is an integer of 1 to 19, preferably 1 to 18, preferably 1 to 17, preferably 1 to 16, preferably 1 to 15, preferably 1 to 14, preferably 1 to 13, preferably 1 to 12, preferably 1 to 11, preferably 1 to 10, preferably 1 to 9, preferably 1 to 8, preferably 1 to 7, preferably 1 to 6, preferably 1 to 5, preferably 1 to 4, preferably 1 to 3, preferably 1 to 2, most preferably 1. In another embodiment, y is an integer of 1 to 19, preferably 1 to 18, preferably 1 to 17, preferably 1 to 16, preferably 1 to 15, preferably 1 to 14, preferably 1 to 13, preferably 1 to 12, preferably 1 to 11, most preferably 1 to 10. In a preferred embodiment, x is 1 and y is an integer of 1 to 10. In some embodiments, y is an integer of 1 to 10 such as 1, 2, 3, 4, 5, 6, 7, 8, 9, or 10. In some embodiments, x is an integer of 1 to 19, preferably 2 to 18, preferably 3 to 17, preferably 4 to 16, preferably 5 to 15, preferably 6 to 14, preferably 6 to 13, preferably 6 to 12, preferably 6 to 11, preferably 6 to 10, preferably 6 to 9, preferably 6 to 8, preferably 6 to 7, most preferably 6.

In some embodiments, the chemical scale inhibitor composition is an aqueous solution comprising at least 50 ppm of the sulfobetaine zwitterionic surfactant relative to a total volume of the chemical scale inhibitor. In another embodiment, the chemical scale inhibitor composition is an aqueous solution comprising at least 75 ppm of the sulfobetaine zwitterionic surfactant, preferably at least 100 ppm, preferably at least 125 ppm, preferably at least 150 ppm, preferably at least 175 ppm, preferably at least 200 ppm, preferably at least 225 ppm, preferably at least 250 ppm, preferably at least 275 ppm, preferably at least 300 ppm, preferably at least 325 ppm, preferably at least 350 ppm, preferably at least 375 ppm, preferably at least 400 ppm, preferably at least 425 ppm, preferably at least 450 ppm, preferably at least 475 ppm, preferably at least 500 ppm of the sulfobetaine zwitterionic surfactant. In a preferred embodiment, the chemical scale inhibitor composition is an aqueous solution comprising 100 to 500 ppm of the sulfobetaine zwitterionic surfactant relative to a total volume of the chemical scale inhibitor.

In some embodiments, the chemical scale inhibitor composition further comprises at least one additive selected from the group consisting of an ammonium salt, a cross-linking agent, a proppant, an oxygen scavenger, a corrosion inhibitor, a fluid-loss additive, a friction reducer, a chelating agent, a dispersant, a wetting agent, a scale disperser, a pH stabilizer, a de-emulsifier, a hydrate inhibitor, a clay stabilizer, an anti-foaming agent, a viscosifier, a fluid stabilizer, a thermal stabilizer, a flow enhancer, a scale dissolver, a fouling inhibitor, a defoamer, a crystallization inhibitor, and a scale modifier. Ammonium salts, such as quaternary ammonium salts, may be added to chemical scale inhibitor compositions due to their ability to effectively adsorb onto mineral surfaces, disrupting crystal growth and preventing scale formation. Ammonium salts may function across a wide pH range and often require only small concentrations to achieve scale inhibition. Suitable ammonium salts include, but are not limited to, 2-acrylamido-2-methyl propane sulfonic acid (AMPS), alkyltrimethyl ammonium chloride, aminotrimethylene phosphonic acid (ATMP), and ethylenediaminetetramethylene phosphonic acid (EDTMP). Cross-linking agents may be added to chemical scale inhibitor compositions to increase the viscosity and stability of the chemical scale inhibitor, allowing for better suspension and transport of drill cuttings, improved fluid loss control, enhanced wellbore stability, and better performance in high-temperature and high-pressure environments. Suitable cross-linking agents include, but are not limited to, borates (e.g., sodium borate), zirconium compounds (e.g., zirconium oxychloride), transition metals, and certain polymers like guar gum. Proppants may be added to chemical scale inhibitor compositions to reduce the required amount of chemical scale inhibitors to be used within the composition and to extend their length of effectiveness within the wellbore. Suitable proppants include, but are not limited to, silica sand, resin-coated sand, and ceramic sand. Oxygen scavengers may be added to chemical scale inhibitor compositions to react with and remove dissolved oxygen from the drilling system, preventing corrosion. Suitable oxygen scavengers include, but are not limited to, sodium sulfite, sodium bisulfite, sodium metabisulfite, ammonium bisulfite, diethylhydroxylamine (DEHA), and carbohydrazide. Corrosion inhibitors may be added to chemical scale inhibitor compositions to protect surfaces from corrosion within a drilling system, which aids in extending equipment lifespan, reducing maintenance costs, improving operational efficiency, and improving reliability by preventing the build-up of corrosive damage. Suitable corrosion inhibitors include, but are not limited to, phosphates (like orthophosphate), silicates, molybdates, chromates, azoles (benzotriazole, triazole), polyacrylates, and various organic amines. Fluid-loss additives may be added to a chemical scale inhibitor compositions to aid in preventing the chemical scale inhibitor from leaking into the subterranean geological formation, enabling the chemical scale inhibitor to be concentrated where it's needed to effectively inhibit scale formation, thereby maximizing the efficiency of the scale inhibitor and minimizing potential damage to the reservoir rock by maintaining a stable fluid volume within the wellbore. Suitable fluid-loss additives include, but are not limited to, polymeric compounds like carboxymethyl cellulose (CMC), lignosulfonates, modified starches, and high molecular weight polyacrylamides Friction reducers may be added to chemical scale inhibitor compositions to aid delivery of the chemical scale inhibitor to the desired location within a wellbore by reducing friction within the pipe, enabling higher flow rates at lower pumping pressures, thus maximizing the effectiveness of the chemical scale inhibitor treatment and minimizing potential pressure losses during application. Suitable friction reducers include, but are not limited to, polyacrylamide-(PAM-) based polymers, acrylic acids, and acrylamido-methyl-propane sulfonate polymer (AMPS) copolymers. Chelating agents may be added to chemical scale inhibitor compositions to aid in preventing the formation of scales by binding with metal ions in water, sequestering them, and stopping them from participating in the precipitation process that creates scale deposits. Suitable chelating agents include, but are not limited to, ethylenediaminetetraacetic acid (EDTA), diethylenetriaminepentaacetic acid (DTPA), nitrilotriacetic acid (NTA), etidronic acid (HEDP), and various phosphonates. Dispersants may be added to chemical scale inhibitor compositions to prevent newly formed scale particles from clumping together and settling out which helps to maintain system efficiency by preventing blockages and improving flow. Suitable dispersants include, but are not limited to, polyphosphates (e.g., sodium hexametaphosphate), organic phosphonates (e.g., 1-hydroxyethylidene-1,1-diphosphonic acid (HEDP) and aminotrimethylene phosphonic acid (ATMP)), polyacrylic acid (PAA), polymaleic acid, lignosulfonates, acrylate-based polymers, and certain types of cellulose derivatives (e.g., carboxymethyl cellulose). Wetting agents may be added to chemical scale inhibitor compositions to reduce surface tension, enabling the chemical scale inhibitor to better encapsulate and lift the scale precipitates from the wellbore, preventing them from sticking to the formation and ensuring efficient removal to the surface. Suitable examples of wetting agents used in chemical scale inhibitor compositions include, but are not limited to, sodium lauryl sulfate (SLS), polysorbate 80, alkylphenol ethoxylates, poloxamers, and modified starches. Scale dispersers may be added to chemical scale inhibitor compositions to prevent newly formed scale crystals from settling and accumulating on surfaces. Suitable scale dispersers include, but are not limited to, polyacrylates, polymethacrylates, acrylate-based polymers, sulfonated copolymers, and low molecular weight anionic polymers. Chemical scale inhibitor compositions may also comprise pH stabilizers which aid in maintaining a consistent pH level, preventing potential degradation or reduced efficacy of the chemical scale inhibitor due to pH variations. Suitable pH stabilizers include, but are not limited to, polyphosphates, organic phosphonates, polyacrylates, and certain amino acids. De-emulsifiers may be added to chemical scale inhibitor compositions to prevent the formation of emulsions, which can hinder the effectiveness of the scale inhibitor by encapsulating scale-forming ions and impeding their access to the inhibitor. Suitable de-emulsifiers include, but are not limited to, polymeric compounds like poly(ethylene oxide) (PEO) and polyacrylamide (PAM). Hydrate inhibitors, when added to chemical scale inhibitors, aid in the prevention of gas hydrate formations in pipelines and production equipment, thereby allowing for increased producing efficiency. Suitable hydrate inhibitors include, but are not limited to, methanol (MeOH), monoethylene glycol (MEG), and diethylene glycol (DEG). Clay stabilizers added to chemical scale inhibitor compositions may help prevent issues related to clay swelling and dispersion in formations, ensuring the scale inhibitor can effectively reach and target the desired areas for scale prevention. Suitable clay stabilizers may include, but are not limited to, quaternary ammonium compounds (e.g., tetramethylammonium chloride), cationic polymers, choline chloride, potassium chloride, and hydrolyzable metal ions (e.g., zirconium oxychloride). In chemical scale inhibitor compositions, anti-foaming agents may aid in preventing excessive foam formation which can disrupt the scale inhibition process, leading to improved efficiency. Suitable anti-foaming agents include silicones (like polydimethylsiloxane), mineral oils, fatty alcohols, hydrophobic silica, and certain types of long-chain alcohols. In chemical scale inhibitor compositions, viscosifiers may increase the chemical scale inhibitor's viscosity, which helps the inhibitor to better adhere to surfaces, ensuring more even distribution and longer contact time with potential scaling areas, leading to improved scale inhibition efficacy. Examples of viscosifiers include bentonite clay, xanthan gum, guar gum, polyanionic cellulose (PAC), attapulgite clay, carboxymethyl cellulose (CMC), starches (e.g., corn starch or potato starch), and sepiolite clay. Fluid stabilizers in chemical scale inhibitor compositions may help maintain the consistency and effectiveness of the inhibitor by preventing its components from separating or precipitating out of the solution. Suitable fluid stabilizers include, but are not limited to, polymeric compounds like polyacrylates, sulfonated polymers, and copolymers containing both phosphonate and sulfonate moieties. Thermal stabilizers may be added to chemical scale inhibitor compositions to aid in maintaining the inhibitor's desired properties, particularly viscosity and filtration control, even at high temperatures encountered during deep drilling operations, preventing degradation of the inhibitor. Examples of thermal stabilizers include synthetic polymers like 2-acrylamido-2-methylpropane sulfonic acid (AMPS) copolymers, silica nanoparticles, modified natural polymers like lignin or humic acid, and certain types of clays with high thermal stability. Flow enhancers added to chemical scale inhibitor compositions may improve the inhibitor's ability to circulate efficiently within the wellbore, leading to reduced torque and drag, better scale removal, and overall enhanced efficiency. Examples of flow enhancers include polymeric additives such as sulfonated polyacrylic acid (SPAA), polyacrylamide (PAM), and copolymers with functional groups like carboxylate and sulfonate. Chemical scale inhibitor compositions may also contain scale dissolvers, which aid in removing existing mineral scale deposits in addition to preventing new scale formation. Suitable scale dissolvers include, but are not limited to, hydrochloric acid (HCl), organic acids like acetic acid and formic acid, chelating agents like ethylenediaminetetraacetic acid (EDTA) and diethylenetriaminepentaacetic acid (DTPA), acrylic acid, and polyphosphonates like ATMP and polyphosphonocarboxylic acid (PPCA). Fouling inhibitors, when added to chemical scale inhibitor compositions, may aid in preventing the buildup of deposits and fouling on surfaces within a drilling system. Examples of fouling inhibitors include polyphosphates (e.g., sodium hexametaphosphate), organophosphonates (e.g., HEDP), PAA, 2-phosphonobutane-1,2,4-tricarboxylic acid (PBTC), and diethylenetriamine penta(methylene phosphonic acid) (DTPMP).

In chemical scale inhibitor compositions, a defoamer may be added to prevent excessive foam formation, which can hinder the effectiveness of the scale inhibitor by disrupting its distribution and preventing proper contact with the surfaces where scaling occurs. Examples of defoamers may include silicone-based compounds, octyl alcohol, aluminum stearate, various glycols, sulfonated hydrocarbons, and certain types of fatty alcohols. Crystallization inhibitors may be added to chemical scale inhibitors to help prevent the formation of mineral scale deposits on surfaces by interfering with the crystal growth process, minimizing the buildup of deposits on equipment surfaces. Suitable examples of crystallization inhibitors include, but are not limited to, polyphosphates, phosphonates, polyacrylic acid (PAA), carboxylates, sulfonates, diethylenetriaminepenta(methylene phosphonic acid) (DETPMP), and polyaspartic acid (PASP). Scale modifiers in chemical scale inhibitor compositions may aid in preventing scale formation by altering the crystal structure of the scale, reducing the likelihood of large-scale deposits. Examples of scale modifiers include PAA, phosphonates (e.g., HEDP or DTPMP), polycarboxylates, ATMP, EDTA, and sulfonated polymers.

In some embodiments, the chemical scale inhibitor composition further comprises a brine comprising at least one selected from the group consisting of a synthetic seawater and a formation water. In a preferred embodiment, the chemical scale inhibitor composition further comprises a brine comprising a synthetic seawater and a formation water. In some embodiments, the synthetic seawater comprises 0.1 to 0.2 g/L of NaHCO₃. In another embodiment, the synthetic seawater comprises 0.105 to 0.195 g/L NaHCO₃, preferably 0.110 to 0.190 g/L, preferably 0.115 to 0.185 g/L, preferably 0.120 to 0.180 g/L, preferably 0.125 to 0.175 g/L, preferably 0.130 to 0.170 g/L, preferably 0.135 to 0.165 g/L, preferably 0.140 to 0.165 g/L, preferably 0.145 to 0.165 g/L, preferably 0.150 to 0.165 g/L, preferably 0.155 to 0.165 g/L, preferably 0.160 to 0.165 g/L, most preferably 0.165 g/L NaHCO₃. In some embodiments, the synthetic seawater comprises 5.5 to 6.5 g/L of Na₂SO₄. In another embodiment, the synthetic seawater comprises 5.55 to 6.45 g/L, preferably 5.60 to 6.40 g/L, preferably 5.65 to 6.35 g/L, preferably 5.70 to 6.35 g/L, preferably 5.75 to 6.35 g/L, preferably 5.80 to 6.35 g/L, preferably 5.85 to 6.35 g/L, preferably 5.90 to 6.35 g/L, preferably 5.95 to 6.35 g/L, preferably 6.00 to 6.35 g/L, preferably 6.05 to 6.35 g/L, preferably 6.10 to 6.35 g/L, preferably 6.15 to 6.35 g/L, preferably 6.20 to 6.35 g/L, preferably 6.25 to 6.35 g/L, preferably 6.30 to 6.35 g/L, most preferably 6.339 g/L Na₂SO₄. In some embodiments, the synthetic seawater comprises 41 to 42 g/L NaCl. In another embodiment, the synthetic seawater comprises 41.05 to 41.95 g/L NaCl, preferably 41.10 to 41.90 g/L, preferably 41.15 to 41.85 g/L, preferably 41.15 to 41.80 g/L, preferably 41.15 to 41.75 g/L, preferably 41.15 to 41.70 g/L, preferably 41.15 to 41.65 g/L, preferably 41.15 to 41.60 g/L, preferably 41.15 to 41.55 g/L, preferably 41.15 to 41.50 g/L, preferably 41.15 to 41.45 g/L, preferably 41.15 to 41.40 g/L, preferably 41.15 to 41.35 g/L, preferably 41.15 to 41.30 g/L, preferably 41.15 to 41.25 g/L, preferably 41.15 to 41.20 g/L, most preferably 41.172 g/L NaCl. In some embodiments, the synthetic seawater comprises 2 to 3 g/L CaCl₂·2H₂O. In another embodiment, the synthetic seawater comprises 2.05 to 2.95 g/L CaCl₂·2H₂O, preferably 2.10 to 2.90 g/L, preferably 2.15 to 2.85 g/L, preferably 2.20 to 2.85 g/L, preferably 2.25 to 2.85 g/L, preferably 2.30 to 2.85 g/L, preferably 2.35 to 2.85 g/L, preferably 2.40 to 2.85 g/L, preferably 2.45 to 2.85 g/L, preferably 2.50 to 2.85 g/L, preferably 2.55 to 2.85 g/L, preferably 2.60 to 2.85 g/L, preferably 2.65 to 2.85 g/L, preferably 2.70 to 2.85 g/L, preferably 2.75 to 2.85 g/L, preferably 2.80 to 2.85 g/L, most preferably 2.837 g/L CaCl₂·2H₂O. In some embodiments, the synthetic seawater comprises 17 to 18 g/L MgCl₂·6H₂O. In another embodiment, the synthetic seawater comprises 17.05 to 17.95 g/L MgCl₂·6H₂O, preferably 17.10 to 17.90 g/L, preferably 17.15 to 17.85 g/L, preferably 17.20 to 17.80 g/L, preferably 17.25 to 17.75 g/L, preferably 17.30 to 17.70 g/L, preferably 17.35 to 17.65 g/L, preferably 17.40 to 17.65 g/L, preferably 17.45 to 17.65 g/L, preferably 17.50 to 17.65 g/L, preferably 17.55 to 17.65 g/L, preferably 17.60 to 17.65 g/L, most preferably 17.644 g/L MgCl₂·6H₂O.

In some embodiments, the formation water comprises 0.4 to 0.5 g/L of NaHCO₃. In another embodiment, the formation water comprises 0.405 to 0.495 g/L NaHCO₃, preferably 0.410 to 0.490 g/L, preferably 0.415 to 0.490 g/L, preferably 0.420 to 0.490 g/L, preferably 0.425 to 0.490 g/L, preferably 0.430 to 0.490 g/L, preferably 0.435 to 0.490 g/L, preferably 0.440 to 0.490 g/L, preferably 0.445 to 0.490 g/L, preferably 0.450 to 0.490 g/L, preferably 0.455 to 0.490 g/L, preferably 0.460 to 0.490 g/L, preferably 0.465 to 0.490 g/L, preferably 0.470 to 0.490 g/L, preferably 0.475 to 0.490 g/L, preferably 0.480 to 0.490 g/L, preferably 0.485 to 0.490 g/L, most preferably 0.487 g/L NaHCO₃. In some embodiments, the formation water comprises 0.5 to 0.6 g/L of Na₂SO₄. In another embodiment, the formation water comprises 0.505 to 0.595 g/L Na₂SO₄, preferably 0.510 to 0.590 g/L, preferably 0.515 to 0.585 g/L, preferably 0.515 to 0.580 g/L, preferably 0.515 to 0.575 g/L, preferably 0.515 to 0.570 g/L, preferably 0.515 to 0.565 g/L, preferably 0.515 to 0.560 g/L, preferably 0.515 to 0.555 g/L, preferably 0.515 to 0.550 g/L, preferably 0.515 to 0.545 g/L, preferably 0.515 to 0.540 g/L, preferably 0.515 to 0.535 g/L, preferably 0.515 to 0.530 g/L, preferably 0.515 to 0.525 g/L, preferably 0.515 to 0.520 g/L, most preferably 0.518 g/L Na₂SO₄. In some embodiments, the formation water comprises 150 to 151 g/L NaCl. In another embodiment, the formation water comprises 150.05 to 150.95 g/L NaCl, preferably 150.05 to 150.95 g/L, preferably 150.10 to 150.90 g/L, preferably 150.15 to 150.85 g/L, preferably 150.20 to 150.80 g/L, preferably 150.25 to 150.75 g/L, preferably 150.30 to 150.70 g/L, preferably 150.35 to 150.65 g/L, preferably 150.40 to 150.60 g/L, preferably 150.40 to 150.55 g/L, preferably 150.40 to 150.50 g/L, preferably 150.40 to 150.45 g/L, most preferably 150.446 g/L NaCl. In some embodiments, the formation water comprises 69 to 70 g/L CaCl₂·2H₂O. In another embodiment, the formation water comprises 69.05 to 69.95 g/L CaCl₂·2H₂O, preferably 69.10 to 69.90 g/L, preferably 69.15 to 69.85 g/L, preferably 69.20 to 69.85 g/L, preferably 69.25 to 69.85 g/L, preferably 69.30 to 69.85 g/L, preferably 69.35 to 69.85 g/L, preferably 69.40 to 69.85 g/L, preferably 69.45 to 69.85 g/L, preferably 69.50 to 69.85 g/L, preferably 69.55 to 69.85 g/L, preferably 69.60 to 69.85 g/L, preferably 69.65 to 69.85 g/L, preferably 69.70 to 69.85 g/L, preferably 69.75 to 69.85 g/L, preferably 69.80 to 69.85 g/L, most preferably 69.841 g/L CaCl₂·2H₂O. In some embodiments, the formation water comprises 20 to 21 g/L MgCl₂·6H₂O. In another embodiment, the formation water comprises 20.05 to 20.95 g/L MgCl₂·6H₂O, preferably 20.10 to 20.90 g/L, preferably 20.15 to 20.85 g/L, preferably 20.20 to 20.80 g/L, preferably 20.25 to 20.75 g/L, preferably 20.30 to 20.70 g/L, preferably 20.35 to 20.65 g/L, preferably 20.35 to 20.60 g/L, preferably 20.35 to 20.55 g/L, preferably 20.35 to 20.50 g/L, preferably 20.35 to 20.45 g/L, preferably 20.35 to 20.40 g/L, most preferably 20.396 g/L MgCl₂·6H₂O.

In some embodiments, the brine has a weight ratio of the synthetic seawater to the formation water of 1:3 to 3:1, preferably 1:2.8 to 2.8:1, preferably 1:2.6 to 2.6:1, preferably 1:2.4 to 2.4:1, preferably 1:2.2 to 2.2:1, preferably 1:2 to 2:1, preferably 1:1.8 to 1.8:1, preferably 1:1.6 to 1.6:1, preferably 1:1.4 to 1.4:1, preferably 1:1.2 to 1.2:1, most preferably 1:1 of the synthetic seawater to the formation water.

In some embodiments, the chemical scale inhibitor composition has a viscosity of 1 to 250 cP. In another embodiment, the chemical scale inhibitor composition has a viscosity of 5 to 245 cP, preferably 10 to 240 cP, preferably 10 to 235 cP, preferably 10 to 230 cP, preferably 10 to 225 cP, preferably 10 to 220 cP, preferably 10 to 215 cP, preferably 10 to 210 cP, preferably 10 to 205 cP, preferably 10 to 200 cP, preferably 10 to 195 cP, preferably 10 to 190 cP, preferably 10 to 185 cP, preferably 10 to 180 cP, preferably 10 to 175 cP, preferably 10 to 170 cP, preferably 10 to 165 cP, preferably 10 to 160 cP, preferably 10 to 155 cP, preferably 10 to 150 cP, preferably 10 to 145 cP, preferably 10 to 140 cP, preferably 10 to 135 cP, preferably 10 to 130 cP, preferably 10 to 125 cP, preferably 10 to 120 cP, preferably 10 to 115 cP, preferably 10 to 110 cP, preferably 10 to 105 cP, preferably 10 to 100 cP, preferably 10 to 95 cP, preferably 10 to 90 cP, preferably 10 to 85 cP, preferably 10 to 80 cP, preferably 10 to 75 cP, preferably 10 to 70 cP, preferably 10 to 65 cP, preferably 10 to 60 cP, preferably 10 to 55 cP, preferably 10 to 50 cP, preferably 10 to 45 cP, preferably 10 to 40 cP, preferably 10 to 35 cP, preferably 10 to 30 cP, preferably 10 to 25 cP, most preferably 10 to 20 cP.

In some embodiments, the chemical scale inhibitor composition has a density of 1 to 2 g/cm³ at a temperature of 20° C. In another embodiment, the chemical scale inhibitor composition has a density of 1.05 to 1.95 g/cm³ at a temperature of 20° C., preferably 1.10 to 1.90 g/cm³, preferably 1.15 to 1.85 g/cm³, preferably 1.20 to 1.80 g/cm³, preferably 1.20 to 1.75 g/cm³, preferably 1.20 to 1.70 g/cm³, preferably 1.20 to 1.65 g/cm³, preferably 1.20 to 1.60 g/cm³, preferably 1.20 to 1.55 g/cm³, preferably 1.20 to 1.20 g/cm³, preferably 1.20 to 1.45 g/cm³, preferably 1.20 to 1.40 g/cm³, preferably 1.20 to 1.35 g/cm³, preferably 1.20 to 1.30 g/cm³, preferably 1.20 to 1.25 g/cm³, most preferably 1.23 to 1.25 g/cm³.

In an embodiment, the chemical scale inhibitor composition has a pH of 1 to 10. In another embodiment, the chemical scale inhibitor has a pH of 1.5 to 9.5, preferably 2 to 9, preferably 2.5 to 8.5, preferably 3 to 8.5, preferably 3.5 to 8.5, preferably 4 to 8.5, preferably 4.5 to 8.5, preferably 5 to 8.5, preferably 5.5 to 8.5, preferably 6 to 8.5, preferably 6.5 to 8.5, most preferably 7 to 8.5.

At step 54, the method 50 comprises contacting a wall of the wellbore with the chemical scale inhibitor composition to delay an onset of sulfate-comprising scale formation on the wall of the wellbore. In some embodiments, the well bore is contacted with the chemical-scale inhibitor composition for at least 1 h, preferably at least 2 h, preferably at least 3 h, preferably at least 4 h, preferably at least 5 h, preferably at least 6 h, preferably at least 7 h, preferably at least 8 h, preferably at least 9 h, preferably at least 10 h, preferably at least 11 h, preferably at least 12 h, preferably at least 13 h, preferably at least 14 h, preferably at least 15 h, preferably at least 16 h, preferably at least 17 h, preferably at least 18 h, preferably at least 19 h, preferably at least 20 h, preferably at least 21 h, preferably at least 22 h, preferably at least 23 h, most preferably at least 24 h. In another embodiment, a wall of the wellbore is contacted with the chemical scale inhibitor composition for at least 1 day, preferably at least 1.5 days, preferably at least 2 days, preferably at least 2.5 days, preferably at least 3 days, preferably at least 3.5 days, preferably at least 4 days, preferably at least 4.5 days, preferably at least 5 days, preferably at least 5.5 days, preferably at least 6 days, preferably at least 6.5 days, most preferably at least 7 days.

In some embodiments, the wall of the wellbore contacted with the chemical scale inhibitor composition is at a temperature of 100 to 160° F. In another embodiment, the wall of the wellbore contacted with the chemical scale inhibitor composition is at a temperature of 102 to 158° F., preferably 104 to 156° F., preferably 106 to 154° F., preferably 108 to 152° F., preferably 110 to 150° F., preferably 112 to 150° F., preferably 114 to 150° F., preferably 116 to 150° F., preferably 118 to 150° F., preferably 120 to 150° F., preferably 122 to 150° F., preferably 124 to 150° F., preferably 126 to 150° F., preferably 128 to 150° F., preferably 130 to 150° F., preferably 132 to 150° F., preferably 134 to 150° F., preferably 136 to 150° F., preferably 138 to 150° F., preferably 140 to 150° F., preferably 142 to 150° F., preferably 144 to 150° F., preferably 146 to 150° F., preferably 148 to 150° F., most preferably 150° F. In a specific embodiment, the wall of the wellbore contacted with the chemical scale inhibitor composition is at a temperature of 150° F.

In some embodiments, the sulfate-comprising scale comprises at least one selected from the group consisting of barium sulfate, strontium sulfate, magnesium sulfate, sodium sulfate, ammonium sulfate, iron sulfate, lead sulfate, copper sulfate, zinc sulfate, cadmium sulfate, manganese sulfate, nickel sulfate, silver sulfate, thallium sulfate, cobalt sulfate, potassium sulfate, aluminum sulfate, lithium sulfate, cesium sulfate, rubidium sulfate, yttrium sulfate, thorium sulfate, uranium sulfate, chromium sulfate, molybdenum sulfate, tungsten sulfate, zirconium sulfate, hafnium sulfate, gallium sulfate, germanium sulfate, and indium sulfate. In another embodiment, the sulfate-comprising scale comprises at least one selected from the group consisting of calcium sulfate, magnesium sulfate, iron sulfate, and barium sulfate. In a specific embodiment, the sulfate-comprising scale comprises barium sulfate. In another specific embodiment, the sulfate-comprising scale comprises calcium sulfate.

In some embodiments, the onset of sulfate-comprising scale formation is delayed by at least 24 h. In another embodiment, the onset of the sulfate-comprising scale formation is delayed by at least 1.5 days, preferably at least 2 days, preferably at least 2.5 days, preferably at least 3 days, preferably at least 3.5 days, preferably at least 4 days, preferably at least 4.5 days, preferably at least 5 days, preferably at least 5.5 days, preferably at least 6 days, preferably at least 6.5 days, most preferably at least 7 days.

In some embodiments, at a temperature of 100 to 160° F., no sulfate-comprising scale precipitate is formed in an aqueous composition comprising at least 50 ppm of the sulfobetaine zwitterionic surfactant and 0.1 to 0.5 g/L NaHCO₃, 0.5 to 6.5 g/L Na₂SO₄, 40 to 155 g/L NaCl, 2 to 70 g/L CaCl₂·2H₂O, and 17 to 22 g/L MgCl₂·6H₂O. In another embodiment, at a temperature of 100 to 160° F., no sulfate-comprising scale precipitate is formed in an aqueous composition comprising 50 to 500 ppm of the sulfobetaine zwitterionic surfactant, preferably 55 to 500 ppm, preferably 60 to 500 ppm, preferably 65 to 500 ppm, preferably 70 to 500 ppm, preferably 75 to 500 ppm, preferably 80 to 500 ppm, preferably 85 to 500 ppm, preferably 90 to 500 ppm, preferably 95 to 500 ppm, most preferably 100 to 500 ppm of the sulfobetaine zwitterionic surfactant and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O.

In some embodiments, at a temperature of 150° F., no sulfate-comprising scale precipitate is formed in an aqueous composition comprising at least 50 ppm of the sulfobetaine zwitterionic surfactant and 0.1 to 0.5 g/L NaHCO₃, 0.5 to 6.5 g/L Na₂SO₄, 40 to 155 g/L NaCl, 2 to 70 g/L CaCl₂·2H₂O, and 17 to 22 g/L MgCl₂·6H₂O. In another embodiment, at a temperature of 70 to 150° F., no sulfate-comprising scale precipitate is formed in an aqueous composition comprising 50 to 500 ppm of the sulfobetaine zwitterionic surfactant, preferably 55 to 500 ppm, preferably 60 to 500 ppm, preferably 65 to 500 ppm, preferably 70 to 500 ppm, preferably 75 to 500 ppm, preferably 80 to 500 ppm, preferably 85 to 500 ppm, preferably 90 to 500 ppm, preferably 95 to 500 ppm, most preferably 100 to 500 ppm of the sulfobetaine zwitterionic surfactant and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O.

In some embodiments, at a temperature of 150° F., no sulfate-comprising scale precipitate is formed in an aqueous composition comprising at least 100 ppm of the sulfobetaine zwitterionic surfactant and 0.1 to 0.5 g/L NaHCO₃, 0.5 to 6.5 g/L Na₂SO₄, 40 to 155 g/L NaCl, 2 to 70 g/L CaCl₂·2H₂O, and 17 to 22 g/L MgCl₂·6H₂O. In another embodiment, at a temperature of 70 to 150° F., no sulfate-comprising scale precipitate is formed in an aqueous composition comprising at least 110 ppm of the sulfobetaine zwitterionic surfactant, preferably at least 120 ppm, preferably at least preferably at least 130 ppm, preferably at least 140 ppm, preferably at least 150 ppm, preferably at least 160 ppm, preferably at least 170 ppm, preferably at least 175 ppm, preferably at least 180 ppm, preferably at least 190 ppm, preferably at least 200 ppm, preferably at least 210 ppm, preferably at least 220 ppm, preferably at least 230 ppm, preferably at least 240 ppm, preferably at least 250 ppm, preferably at least 260 ppm, preferably at least 270 ppm, preferably at least 280 ppm, preferably at least 290 ppm, preferably at least 300 ppm, preferably at least 310 ppm, preferably at least 320 ppm, preferably at least 330 ppm, preferably at least 340 ppm, preferably at least 350 ppm, preferably at least 360 ppm, preferably at least 370 ppm, preferably at least 380 ppm, preferably at least 390 ppm, preferably at least 400 ppm, preferably at least 410 ppm, preferably at least 420 ppm, preferably at least 430 ppm, preferably at least 440 ppm, preferably at least 450 ppm, preferably at least 460 ppm, preferably at least 470 ppm, preferably at least 480 ppm, preferably at least 490 ppm, most preferably 500 ppm of the sulfobetaine zwitterionic surfactant and 0.1 to 0.5 g/L NaHCO₃, 0.5 to 6 g/L Na₂SO₄, 40 to 155 g/L NaCl, 2 to 70 g/L CaCl₂·2H₂O, and 17 to 20 g/L MgCl₂·6H₂O.

### EXAMPLES

The following examples demonstrate a method of inhibiting sulfate-comprising scale in a subterranean geological formation as described herein. The examples are provided solely for illustration and are not to be construed as limitations of the present disclosure, as many variations thereof are possible without departing from the spirit and scope of the present disclosure.

### Example 1: Materials

In the present disclosure, a sulfobetaine zwitterionic surfactant of Formula I was used as a scale inhibitor

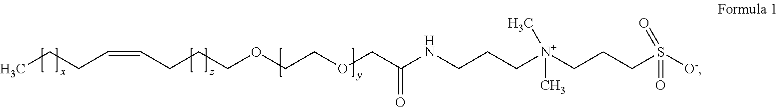

where x, y, and z are individually an integer from 1 to 20. The composition of the synthetic sea water (SW) and formation water (FW) are listed in Table 1. The total dissolved solids in SW and FW are 67707 ppm and 241688 ppm, respectively.

TABLE 1
Salt composition of SW and FW

| Salts | Sea water (g/L) | Formation water (g/L) |
|---|---|---|
| NaHCO₃ | 0.165 | 0.487 |
| Na₂SO₄ | 6.339 | 0.518 |
| NaCl | 41.172 | 150.446 |
| CaCl₂•2H₂O | 2.387 | 69.841 |
| MgCl₂•6H₂O | 17.644 | 20.396 |

### Example 2: Prevention of Scale Formation with the Chemical Scale Inhibitor at 150° F.

A synthetic brine comprising the synthetic sea water and formation water was mixed in a 50:50 ratio to generate scale and the sulfobetaine zwitterionic surfactant was added in different percentages. As a control, the scale was formed in the base sample without adding any surfactant. The range of concentrations evaluated was from 100 to 500 ppm of the sulfobetaine zwitterionic surfactant. Table 2 lists the static bottle evaluation results of the sulfobetaine zwitterionic surfactant as a scale inhibitor, conducted in a SW and FW mixture at a temperature of 150° F.

TABLE 2
Scale testing at 150° F. with a plurality
of zwitterionic surfactant concentration

| | Surfactant | | | | |
|---|---|---|---|---|---|
| Formulations | Concentrations | | Temperature | 1 day | 7 days |
| Base (SW:FW) | 0 | ppm | 150° F. | Scale | Scale |
| Surfactant | 100 | ppm | | blank | Minimal |
| | | | | | Precipitation |
| | 500 | ppm | | blank | Minimal |

Precipitation

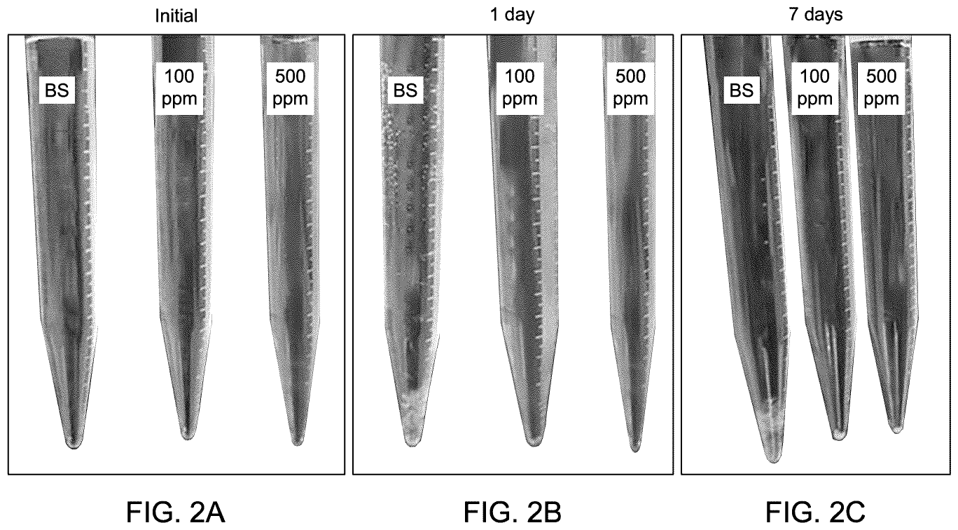

The test tubes were kept at 150° F. for varying time intervals, in order to assess the scale inhibition performance of the sulfobetaine zwitterionic surfactant. In particular, FIGS. 2A through 2C depict the initial condition of the test tubes and their state at various intervals including 0 days (initial), 1 day, and 7 days. As can be seen from FIGS. 2A through 2E, the test tubes are labeled with different concentration values including base sample (BS or control), 100 ppm, and 500 ppm, indicating the concentration of the sulfobetaine zwitterionic surfactant in each test tube. The progression of time shows changes in the clarity of the solutions, indicating the efficacy of the scale inhibitor at different concentrations over time with the cloudiness of a solution indicating the potential beginnings of scale formation. The test tubes in which the zwitterionic surfactant was added, showed no marks of scale formation, at 100 ppm and 500 ppm, after a period of about 1 day. Further, after seven days, there was minimal precipitation observed at the bottom of the test tubes. However, the morphology of the precipitation was different from the base sample. In the base sample, the scale formed was in a needle shape while, in the zwitterionic surfactant sample, the precipitate observed had a rounded shape, as shown in FIGS. 2A through 2C.

Numerous modifications and variations of the present disclosure are possible in light of the above teachings. It is therefore to be understood that within the scope of the appended claims, the invention may be practiced otherwise than as specifically described herein.

1. A method of inhibiting sulfate-comprising scale formation in a high-pressure high-temperature (HPHT) wellbore, comprising:
injecting a chemical scale inhibitor into a wellbore disposed in a subterranean geological formation to form a chemical scale inhibitor composition in the wellbore;
contacting a wall of the wellbore with the chemical scale inhibitor composition to delay an onset of sulfate-comprising scale formation on the wall of the wellbore,
wherein the chemical scale inhibitor is a sulfobetaine zwitterionic surfactant of Formula I 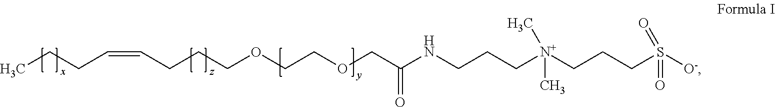
wherein x, y, and z are individually an integer from 1 to 20,
wherein the chemical scale inhibitor composition comprises at least 50 ppm of the sulfobetaine zwitterionic surfactant,
wherein the onset of sulfate-comprising scale formation is delayed by at least 24 h, and
wherein the wall of the wellbore contacted with the chemical scale inhibitor composition is at a temperature of at least 100° F.

2. The method of claim 1, wherein the sulfate-comprising scale comprises at least one selected from the group consisting of barium sulfate, calcium sulfate, and strontium sulfate,
wherein after 24 hours an amorphous precipitate having a rounded shape is formed, and
wherein x and y are 1, and z is from 2 to 10.

3. The method of claim 1, wherein no sulfate-comprising scale precipitate is formed in an aqueous composition comprising 0.4 to 0.5 g/L NaHCO₃, 0.5 to 7 g/L Na₂SO₄, 40 to 155 g/L NaCl, 2 to 70 g/L CaCl₂·2H₂O, 17 to 22 g/L MgCl₂·6H₂O, and 100 to 500 ppm of the sulfobetaine zwitterionic surfactant at a temperature of 100 to 160° F.

4. The method of claim 1, wherein the contacting is performed for at least 1 hour.

5. The method of claim 1, wherein the sulfate-comprising scale comprises barium sulfate.

6. The method of claim 1, wherein no sulfate-comprising scale precipitate is formed in an aqueous composition comprising 0.15 to 0.5 g/L NaHCO₃, 0.5 to 6.5 g/L Na₂SO₄, 41 to 151 g/L NaCl, 2.3 to 70 g/L CaCl₂·2H₂O, 17.5 to 21 g/L MgCl₂·6H₂O, and 100 to 500 ppm of the sulfobetaine zwitterionic surfactant at a temperature of 100 to 160° F.

7. The method of claim 1, wherein the chemical scale inhibitor composition further comprises at least one additive selected from the group consisting of an ammonium salt, a cross-linking agent, a breaker delay agent, a proppant, a gas component, a breaker aid, an oxygen scavenger, a corrosion inhibitor, a fluid-loss additive, a biocide, a bactericide, and a friction reducer.

8. The method of claim 1, wherein the wall of the wellbore contacted with the chemical scale inhibitor composition is at a temperature of 100 to 160° F.

9. The method of claim 1, wherein the sulfate-comprising scale comprises calcium sulfate.

10. The method of claim 1, wherein the chemical scale inhibitor composition comprises at least 100 ppm of the sulfobetaine zwitterionic surfactant.

11. The method of claim 1 wherein x is 1, y is an integer from 1 to 10, and z is 6.

12. The method of claim 1, wherein the wall of the wellbore contacted with the chemical scale inhibitor composition is at a temperature of 150° F.

13. The method of claim 1, wherein the contacting is performed for at least 24 hours.

14. The method of claim 1, wherein the chemical scale inhibitor composition further comprises synthetic seawater comprising 0.1 to 0.2 g/L NaHCO₃, 5.5 to 6.5 g/L Na₂SO₄, 41 to 42 g/L NaCl, 2 to 3 g/L CaCl₂·2H₂O, and 17 to 18 g/L MgCl₂·6H₂O, and/or
formation water comprising 0.4 to 0.5 g/L NaHCO₃, 0.5 to 0.6 g/L Na₂SO₄, 150 to 151 g/L NaCl, 69 to 70 g/L CaCl₂·2H₂O, and 20 to 21 g/L MgCl₂·6H₂O.

15. The method of claim 1, wherein the chemical scale inhibitor composition further comprises a brine comprising a synthetic seawater and a formation water, and
wherein the brine has a weight ratio of the synthetic seawater to the formation water of 1:3 to 3:1.

16. The method of claim 1, wherein the chemical scale inhibitor composition comprises at least 500 ppm of the sulfobetaine zwitterionic surfactant.

17. The method of claim 1, wherein the chemical scale inhibitor composition has a viscosity of 1 to 20 cP.

18. The method of claim 1, wherein the chemical scale inhibitor composition has a density of 1.15 to 1.30 g/cm³.

19. The method of claim 1, wherein the chemical scale inhibitor composition has a pH of 3 to 7.

20. The method of claim 1, wherein the chemical scale inhibitor composition has a density of 1.23 to 1.25 g/cm³.
